(19) United States
(12) Patent Application Publication
(10) Pub. No.: US 2014/0317188 A1
(43) Pub. Date: Oct. 23, 2014

(54) METHOD AND SYSTEM FOR ENABLING THEME AND LOCATION BASED PARTICIPATION IN A SOCIAL NETWORK

(71) Applicant: KRISTA THORNE-YOCAM, SANTA CRUZ, CA (US)

(72) Inventor: KRISTA THORNE-YOCAM, SANTA CRUZ, CA (US)

(21) Appl. No.: 14/254,416

(22) Filed: Apr. 16, 2014

Related U.S. Application Data
(60) Provisional application No. 61/812,524, filed on Apr. 16, 2013.

(51) Int. Cl. H04L 29/08

(52) U.S. Cl. CPC H04L 67/10; H04L 67/18
USPC 709/204

(57) ABSTRACT

A method and system for associating themes of member groups of a social networking system are associated with geographic data related to group members. Network members may self identify a locale to be associated with their online identity. A non-member of the group may search for group themes and be enabled to view indications of group member locations prior to requesting group membership. Member locales may be indicated within a rendered map image. Groups include selected members of the social network and each group preferably is associated with one or more themes, e.g., ideas, concepts, images, and topics. One or more members may have a specified status within a group wherein status assignments limit and/or empower relevant members of the group with privileges, authorities and/or obligations. Resources may be associated with a group, wherein a resource may be recommended by a group member, a sponsor, and/or the social networking system.

The present Nonprovisional Patent Application is a Continuation-in-Part Patent Application of U.S. Provisional Patent Application Ser. No. 61/812,524, filed on Apr. 16, 2013. The present Nonprovisional Patent Application claims the priority date of Provisional Patent Application Ser. No. 61/812,524. Furthermore, Provisional Patent Application Ser. No. 61/812,524 is hereby incorporated into the present Nonprovisional Patent Application in its entirety and for all purposes.

### FIELD OF THE INVENTION

The present invention relates to social networking systems enabled by information technology. More particularly, the present invention relates to methods of, and systems for, enabling user interaction with members and users of social networking systems to address and share information relayed to user-selected topics, concerns and issues.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The present invention relates generally to social networking, and in particular to methods and means of providing information relevant to a user of an electronically mediated and enabled social networking system. Information technology based social networking systems have become prevalent in recent years because they provide a useful environment in which users can connect to and communicate with other users. A variety of different types of social networking systems exist that provide mechanisms allowing users to interact within their social networks. In this context, a user may be an individual or any other entity, such as a business or other non-person entity. Accordingly, while enabling social communications among friends, a social networking system can also be a valuable tool for individuals, groups and representatives of groups finding and connecting with other parties who are concerned with certain issues, other topics related to selected issues, similar themes.

Many members of social networks and potential participants in social networks find the geographic distribution of participants in a discussion group to be relevant to the desirability of joining in or paying attention to a given discussion, online community, or subset of a social network. However, the prior art fails to optimally and efficiently address these two desires of many parties to find (a.) groups within a social network that focus on a topic of interest, and (b.) have access to the geographic association of one or more members of a group or participants in a discussion.

### SUMMARY OF THE INVENTION

Toward this object and other objects that are made obvious to one of ordinary skill in the art in light of the present disclosure, a method of providing information to a participant having access to a social networking system is provided. In one aspect of the method of the present invention, information related to groups and discussion associated with one or more themes, topics, expressed ideas, and expressions and images representing ideas is made accessible to an enquiring party along with access to at least some geolocational information associated with members of one or more groups or participants in one or more discussions. In accordance with method of the present invention (hereinafter, “the invented method”) the geolocational information may comprise or be a name of a locale, a name of a community, a pair of geographic coordinates, and/or other identifier of a place on Earth.

In an optional aspect of the invented method, one or more locations of group members may be displayed or indicated within or in association with a rendering of a geographic map image.

In an alternate preferred embodiment of the invented method, a user of a social networking system enters a query into the a social networking system that indicates a theme. The social networking system then queries a database system and determines if there are any defined groups of members that indicate the theme named in the user-query as being of concern or interest. When a match is found between a theme of a user-query and a thematic association of a group, the user is enabled access to information related to self-identified locations of members of the selected group. The enquiring user may thus make an evaluation of the appeal of joining a social networking system group on the basis of both group themes and locations of members of particular groups.

It is understood that two or more groups may have same or similar themes and that an enquiring user may be provided information concerning the locations of members of two or more groups. It is further understood that, in an optional aspect of the invented method, groups associated with expressions of themes or ideas that are synonymous with a theme stated in a user-enquiry may be selected and provided to the enquiring user in a search conducted by the social networking system in response to the user enquiry.

In another optional aspect of the invented method, a member account may be assigned a status within a group that may limit and/or empower each user of the assigned account with authority or privileges in making posts to discussions, moderating a group or related discussions, allowing group membership, denying group membership, sanctioning a group member, reporting abuse behavior, terminating group membership, offering group membership, terminating a group, modifying a group's expressed theme, adding to a group's expressed or indicated range of interest, recommending or posting information about resources and/or hyperlinks to webpage addresses of the World Wide Web, posting comments associated with the group, and/or forming a group.

In a yet other optional aspect of the invented method, recommending or posting information about resources and/or hyperlinks to webpage addresses of the World Wide Web provided by sponsors may be rendered in association with one or more groups of the social networking system.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1A is a network diagram of one embodiment of a system for providing social networking system user notifications;

FIG. 1B is a block diagram of one embodiment of a social networking system of FIG. 1B;

FIG. 2A is an exemplary first screen shot of a response to an exemplary user query as rendered on a display screen of the user device of FIG. 1A wherein a plurality of group names and screen names are displayed;

FIG. 2B is an exemplary first screen shot of a response to an exemplary user query as rendered on a display screen of the user device of FIG. 1A wherein a plurality of group names and screen names are displayed are shown in concert with a map image;

FIG. 3A is a representation of an exemplary first group record of the social networking system of FIG. 1A;

FIG. 3B is an additional representation of the exemplary first group record of FIG. 3B and showing particular theme expressions, user statuses, and histories of submissions to the exemplary first group defined by the first group record;

FIG. 3C is a representation of an exemplary first member account record of the social networking system of FIG. 1A;

FIG. 4 is a flowchart of the social networking system of FIG. 1A interacting with the user device of FIG. 1A in an enquiry related to a theme;

FIG. 5 is a flowchart of the user device of FIG. 1A in rendering group data and in generating a request to join a group;

FIG. 6 is a flowchart of the social networking system of FIG. 1 processing a request to post a message within a group chat;

FIG. 8A is a flowchart of the social networking system of FIG. 1A processing a request to join a group related to a group defined by a group record of FIG. 1B;

FIG. 8B is an illustration of a group chat with resource information as published by the social networking system of FIG. 1A via the electronics communication network of FIG. 1A;

FIG. 9A is a flowchart of the social networking system of FIG. 1A in posting a contributor resource information related to a group record;

FIG. 9B is a block diagram of a contributor resource record assessable by the process of FIG. 9A;

FIG. 10A is a flowchart of the social networking system of FIG. 1A in posting a sponsor resource information related to a group record;

FIG. 10B is a block diagram of a sponsor resource record assessable by the process of FIG. 10A;

FIG. 11 presents a block diagram of elements of the user device of FIG. 1A;

FIG. 12 presents a block diagram of additional optional aspects of the invented system and particularly the user device FIG. 1A; and

FIG. 13 presents a block diagram of additional optional aspects of the exemplary first member account record of FIG. 3C.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

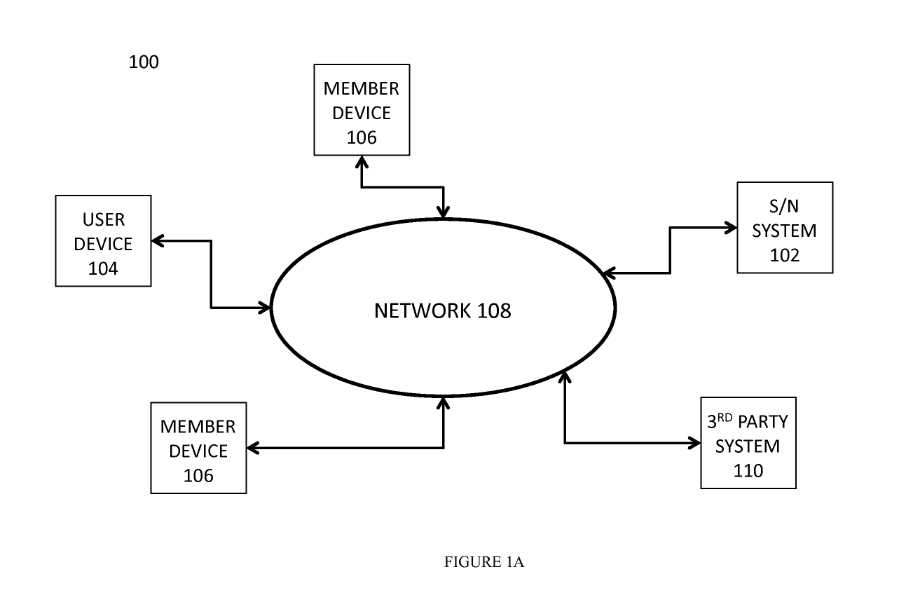

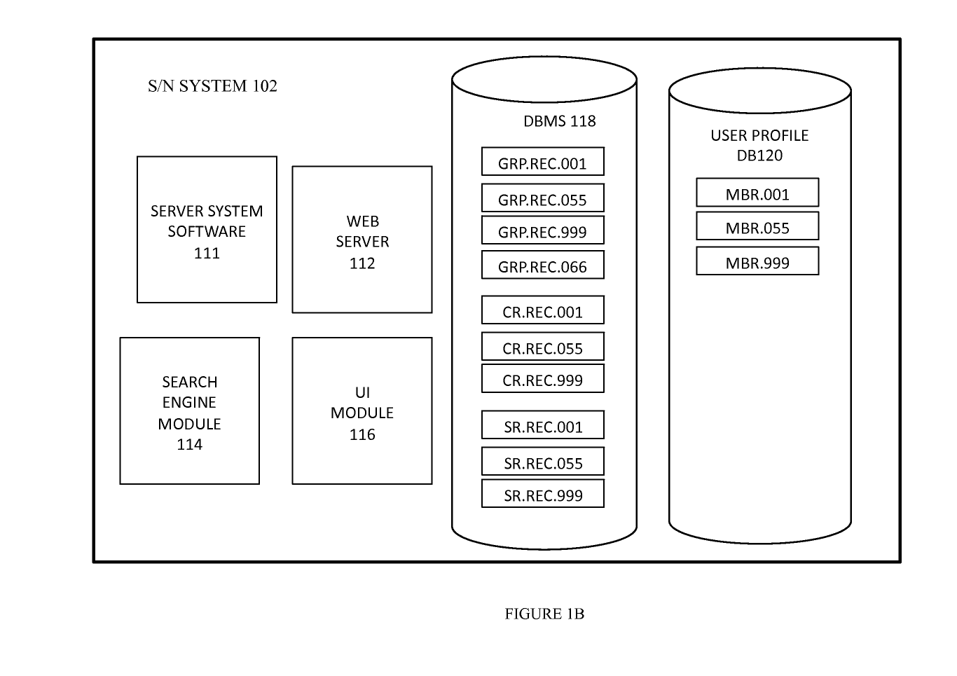

Referring now generally to the Figures and particularly to FIG. 1A, FIG. 1A is a network diagram of one embodiment of an invented system 100 for providing moderated and electronically mediated communications and group communications services among users, to include members, of a social networking system 102. The system 100 includes one or more user devices 104, a plurality of member devices 106, the social networking system 102, an electronics communications network 108, and third party content providers 110. For purposes of illustration, the embodiment of the system 100 shown by FIG. 1 includes a plurality of participant systems 106 and a single user device 104. However, in other embodiments, the system 100 may include more user devices 104 and/or more third-party informational content providers 110. In certain embodiments, the social networking system 102 is operated by the social network provider, such as the FACEBOOK (™) social network service, the LINKEDIN (™) social networking system, or other suitable social networking systems and electronics communications network service providers known in the art. The social networking system 102 provides a platform, or backbone, which other systems and devices 104 & 106, such as third-party informational content providers 110, may use to provide social networking services and functionalities to users across the network 108, e.g., the Internet, the Internet in combination with a telephony network and/or wireless communications channels, and/or suitable alternate electronics communications devices known in the art.

It is understood that the user device 104 is an exemplary member device 106 that is associated with a unique element number of 104 for the purposes of clarity of illustration only and not offered as an indication of any limitation. Furthermore, the term “user” is used in the present disclosure to indicate that in certain versions and alternate preferred embodiments of the invented method that a person or other entity may interact with the social networking system 102 without need of referencing, or being an authorized user of, a member account or a member account record MBR.001-MBR.N.

The user device 104 and each member device 106 comprises one or more computing devices that can receive input from a user and can transmit and receive data via the network 108. For example, the user device 104 and one or more member devices 106 may be a desktop computer, a laptop computer, a smart phone, a personal digital assistant (PDAs) or any other device including computing functionality and data communication capabilities. The user device 104 and each member device 106 are configured to communicate with the social networking system 102 via the network 108, which may comprise any combination of local area and/or wide area networks, using both wired and wireless communication systems. In one embodiment, the user device 104 and one or more member devices 106 display content received from the social networking system 102.

The user device 104 and/or one or more member devices 106 may be or comprise a bundled computer hardware and computer software product such as (a.) a network-communications enabled THINKSTATION WORKSTATION (™) notebook computer marketed by Lenovo, Inc. of Morrisville, N.C.; (b.) a NIVEUS 5200 computer workstation marketed by Penguin Computing of Fremont, Calif. and running a LINUX (™) operating system or a UNIX (™) operating system; (c.) a network-communications enabled personal computer configured for running WINDOWS XP (™), VISTA (™) or WINDOWS 7 (™) operating system marketed by Microsoft Corporation of Redmond, Wash.; (d.) a MACBOOK PRO (™) personal computer as marketed by Apple, Inc. of Cupertino, Calif.; (e.) an IPAD (™) tablet computer as marketed by Apple, Inc. of Cupertino, Calif.; (f.) a TOUGHPAD (™) tablet computer as marketed by Panasonic Corporation of Kadoma, Osaka, Japan and running an ANDROID (™) operating system as marketed by Google, Inc. of Mountain View, Calif.; (h.) an IPHONE ™digital cellular telephone marketed by Apple, Inc. of Cupertino, Calif. or (h.) other suitable smart phone, tablet computer, computational system, and/or electronic communications device known in the art known in the art.

One or more third-party informational content providers 110 comprise one or more sources of software-encoded content, which are communicated to the user device 104 at appropriate times. In one embodiment, the third-party informational content provider 110 is a separate entity from the social networking system 102. For example, the third-party informational content provider 110 is associated with a first domain while the social networking system 102 is associated with a separate social networking domain. In various embodiments, the third-party informational content provider 110 is located on a website or alternatively a server, separate or in conjunction from the website or server that hosts the social networking system 102.

The social networking system 102 comprises one or more computing devices storing a social network, or a social graph, comprising a plurality of users and providing users of the social network with the ability to communicate and interact with other users of the social network. According to various embodiments, the social networking system 102 may comprise a website, or alternatively a server that can be accessed through a wired or wireless network 108 by the user device 104, one or more member devices 106, and/or third-party informational content providers 110. In use, users join the social networking system 102 and then add connections (i.e., relationships) to a number of other users of the social networking system 102 to whom they desire to be connected. As used herein, the term “friend” refers to any other user of the social networking system 102 to whom a user has formed a connection, association, or relationship via the social networking system 102. Connections may be added explicitly by a user or may be automatically created by the social networking systems 102 based on common characteristics of the users (e.g., users who are alumni of the same educational institution). For example, a first user specifically selects a particular other user to be a friend. Connections in the social networking system 102 are usually in both directions, but need not be, so the terms “user” and “friend” depend on the frame of reference. Connections between users of the social networking system 102 are usually bilateral, or “mutual,” but connections may also be unilateral, or “one-way.” For example, if Bob and Joe are both users of the social networking system 102 and connected to each other, Bob and Joe are each other's connections. If, on the other hand, Bob wishes to connect to Joe to view data communicated to the social networking system by Joe but Joe does not wish to form a mutual connection, a unilateral connection may be established. The connection between users may be a direct connection; however, some embodiments of a social networking system allow the connection to be indirect via one or more levels of connections or degrees or separation. Using a social graph, therefore, a social networking system 102 may keep track of many different types of information, interactions and connections within the system 100, thereby maintaining an extremely rich store of socially relevant information.

In addition to establishing and maintaining connections between users and members and allowing interactions between users and members, the social networking system 102 provides users and members with the ability to join and/or communicate with electronically mediated and optionally moderated groups that are supported by the social networking system 102. These groups may be formed to include members of networks (where “networks” here refer not to physical communication networks, but rather social networks of people, entities, and concepts) to which users and members of the social networking system may belong and a user and/or member may be enabled to communicate with by means of the social networking system and/or by additional means.

It is understood that a user or a member may be enabled by the social networking system 102 to communicate with and/or interact with anything that is capable of being represented in the social networking system 102 or by an external system of the third-party informational content provider 110, which is separate from the social networking system 102 and coupled to the social networking system 102 via a network 108.

The social networking system 102 is also capable of linking a variety of entities. For example, the social networking system 102 enables users and members to interact with each other as well as receive content from third-party informational content providers 110 or other entities, or to allow users to interact with these entities through an API or other communication channels.

The social networking system 102 also includes user-generated informational content, which enhances a user's interactions with the social networking system 102. User-generated content may include anything a user can add, upload, send, or “post,” to the social networking system 102. For example, a user communicates posts to the social networking system 102 from a user device 104. Posts may include data such as commentary meant for inclusion in a group chat, status updates or other textual data, location information, photos, videos, links, music or other similar data and/or media. Content may also be added to the social networking system 102 by a third-party through a “communication channel,” such as a newsfeed or stream. In these ways, users of the social networking system 102 are encouraged to communicate with each other by posting text and informational content of various types through various communication channels, increasing the interaction of users with each other and increasing the frequency with which users interact with the social networking system 102.

FIG. 1B is a block diagram of one embodiment of a social networking system 102. The embodiment of a social networking system 102 shown by FIG. 1B includes a server system software 111, a web server software 112, a search engine software module 114, a member interface software module 116, a member account database management system software 118 and a member connection database software 120.

The server system software 111 preferably includes an operating system and additional software code that enables the social network system 102 to effectively engage in interaction with the user device 104, the plurality of user devices 106, the third party system 110, the network 108 and other elements of the invented system 100 in accordance with the aspects and steps of the invented method as disclosed herein. In other embodiments, the social networking system 102 may include additional, fewer, or different modules for various applications. Conventional components such as network interfaces, security mechanisms, load balancers, failover servers, management and network operations consoles, and the like are not shown so as to not obscure the details of the social networking system 102.

As described above in conjunction with FIG. 1A, the social networking system 102 comprises a computing system that allows members to communicate or otherwise interact with each other and access content as described herein. The social networking system 102 stores member account records MBR.001-MBR.999 assigned to individual members of a social network in the member account database management system (hereinafter, “DBMS” 118). The information stored in one or more member account records MBR.001-MBR.999 may include biographic, demographic, and other types of descriptive information, such as work experience, educational history, hobbies or preferences, interests, location, and the like. For example, the DBMS 118 contains data structures with fields suitable for describing a member's profile. When a new object of a particular type is created, the social networking system 102 initializes a new data structure, i.e., a “node” of the corresponding type, assigns a unique object identifier to it, and begins to add data to the object as needed. This might occur, for example, when a member becomes a member of the social networking system 102, the social networking system 102 generates a new instance of a member profile in the DBMS 118, assigns a unique identifier to the member profile, and begins to populate the fields of the member profile with information provided by the member.

In addition, the DBMS 118 may include data structures suitable for describing a member's demographic data, behavioral data, and other social data. Demographic data typically includes data about the member, such as age, gender, location, etc., e.g., as included in the member's profile. Behavioral data typically includes information about the member's activities within the social networking system 102, such as specific actions (posts, likes, comments, etc.), activity levels, usage statistics, etc. Other social data comprises information about the member from within the social networking system 102 that is not strictly demographic or behavioral, such as interests or affinities, etc. In one embodiment, member's interests may be explicitly specified in the member's profile or interests that may be inferred from the member's activities in the social networking system (e.g., uploaded content, postings, reading of messages, etc). Additionally, the DBMS 118 includes logic for maintaining member interest information for members according to one or more categories. Categories may be general or specific, e.g., if a member “likes” an article about a brand of shoes the category may be the brand, or the general category of “shoes” or “clothing.” Multiple categories may apply to a single member interest. In addition, the DBMS 118 may be accessed by other aspects of the social networking system 102.

For example, the DBMS 118 includes logic for maintaining interest information for members according to one or more categories. Categories may be general or specific, e.g., if a member “likes” an article about a brand of shoes the category may be the brand, or the general category of “shoes” or “clothing.” Multiple categories may apply to a single member interest. In addition, the DBMS 118 may be accessed by other aspects of the social networking system 102.

The social networking system 102 further stores data describing one or more connections between different members in a member connection database 120. The connection information may indicate members who have similar or common work experience, group memberships, hobbies, educational history, or are in any way related or share common attributes. Additionally, the social networking system 102 includes member-defined connections between different members, allowing members to specify their relationships with other members. For example, member-defined connections allow members to generate relationships with other members that parallel the members' real-life relationships, such as friends, co-workers, partners, and so forth. Members may select from predefined types of connections, or define their own connection types as needed. The connection database 120 includes data structures suitable for describing a member's connections to other members, connections to third party systems 110, or connections to other entities. The connection stores may also associate a connection type with a member's connections, which may be used in conjunction with the member's privacy setting, to regulate access to information about the member. In addition, the connection database 120 may be accessed by other aspects of the social networking system 102.

The web server 112 links the social networking system 102 to one or more member devices 104 & 106 and/or one or more third party systems 110 via the network 108. The web server 112 serves web pages, as well as other web-related content, such as Java, Flash, XML, and so forth. The web server 112 may include a mail server or other messaging functionality for receiving and routing messages between the social networking system 102 and one or more member devices 104 & 106. The messages can be instant messages, queued messages (e.g., email), text and SMS messages, or any other suitable messaging format.

Any information that a particular member provides with respect to a group GP.001-GP.999 or another member is associated with each member's associated member account record MBR.001-MBR.999, through information maintained in the DBMS 118 or in a similar database or other data repository. Examples of information provided by a member within the social network 102 that are identified and stored may include, for example, providing textual, graphic or photographic data to a chat of a group GP.001-GP.999, adding a connection to another member, sending a message to another member, reading a message from another member, viewing content associated with another member, attending an event posted by another member or other actions interacting with another member.

The social networking system 102 may receive a request to associate information, such as information provider by a member of the social network or a member associated with a member account record MBR.001-MBR.999, with a group record GP.001-GP.999 of the social networking system 102.

A user interface (or Member Interface) module 116 is configured to display a ranked list of search results on a user device 104 or member device 106 that have been ranked by a search engine module 114. The search engine module 114 is configured to respond to user queries provided through the user interface module 116 that specify a theme name THEME.001-THEME.999 by attempting to match the instant theme name THEME.001-THEME.999 with a group name record GP.001-GP.999 that is associated with the theme name THEME.001-THEME.999 specified in an instant query.

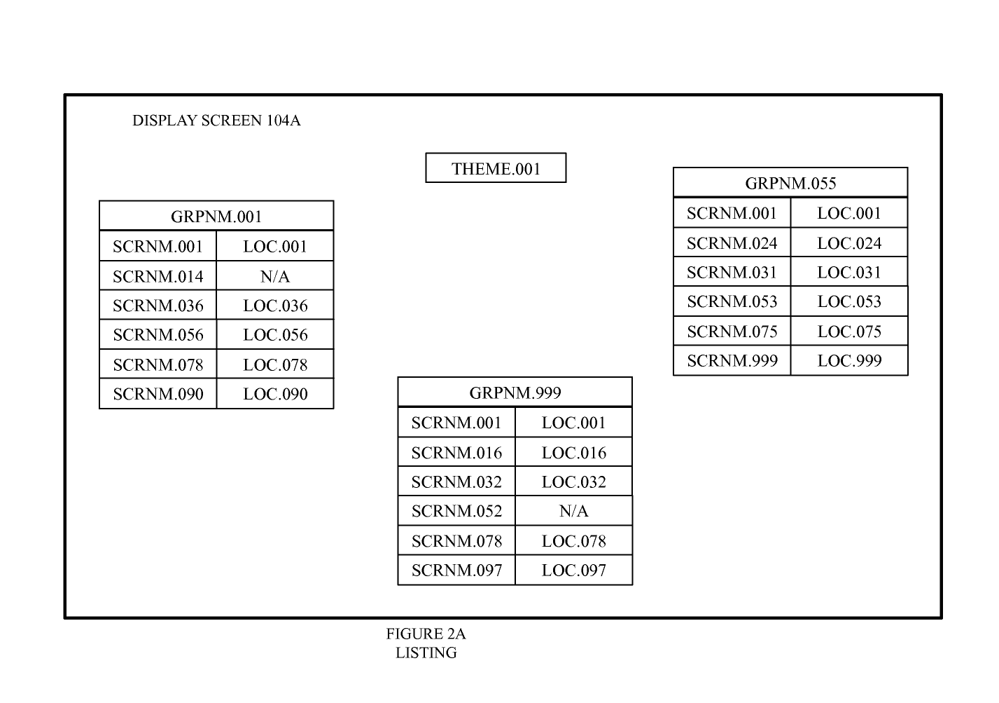

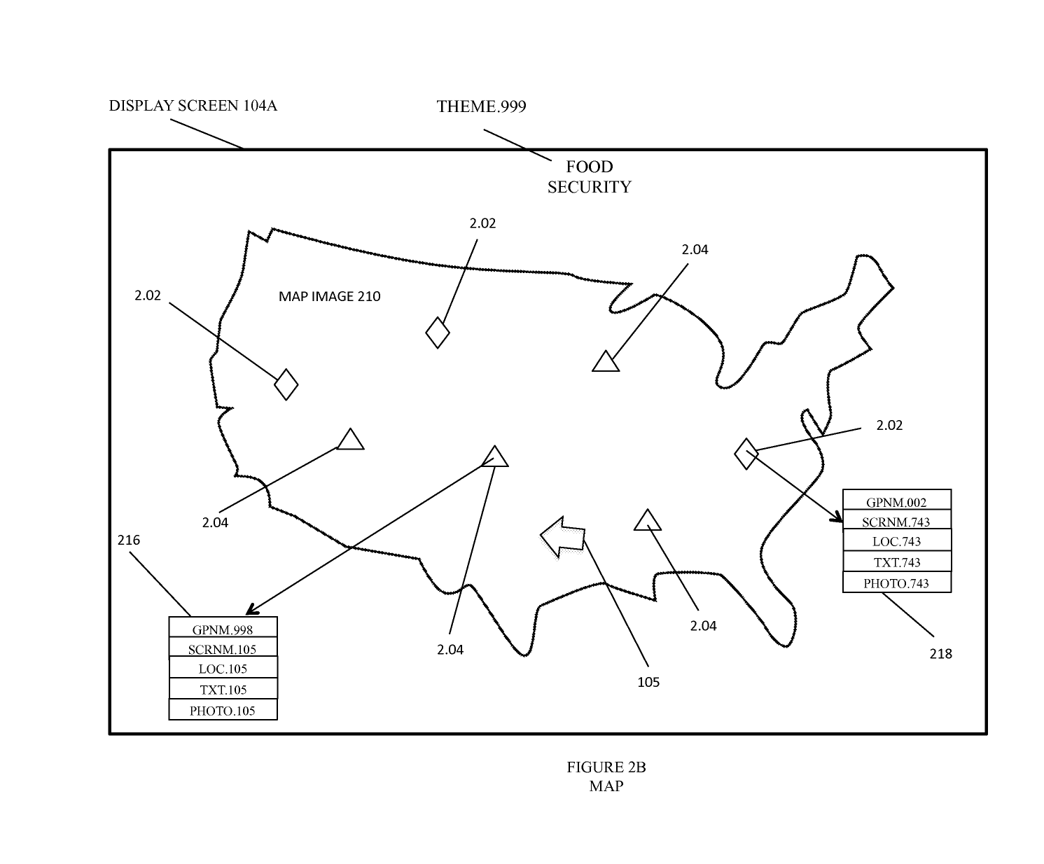

Referring now generally to the Figures and particularly to FIG. 2A, FIG. 2A is an exemplary first screen shot 200 of a response to an exemplary user query as rendered on a display screen 104A of the user device 104. The displayed information includes three group names GRPNM.001, GP.055 & GRPNM999 of groups GP.001, GP.055 & GP.999 that are defined and/or maintained by the social networking system 100. The query exemplary user query asked for groups that are associated with an exemplary first theme THEME.001. It is understood that one or more groups GP.001-GP.999 may be associated with one or more themes THEME.001-THEME.999. The term theme is defined herein include any word, image, symbol, or information that can be represented as a digitized data string or record within the invented system 100.

The rendered windows 202-206 separately include screen names SCRNM.001-SCRNM.999 that are each identified by the server 102 as being associated with a group name GRPNM.001-GP.999 maintained by the system 100. Each window 202-206 includes only those screen names SCRNM.001-SCRNM.999 that are identified by the social networking system 102 as being associated with the group name GRPNM.001-999 that is concurrently displayed in the comprising window 202-206. In addition, one or more screen names SCRNM-001-SCRNM.999 are each individually associated with a specific location name LOC.001-LOC.999 in its comprising rendered window 202-206. It is understood that one or more screen names SCRNM-001-SCRNM.999 may alternatively, additionally or optionally not presented in association with a location name, as evidenced in the exemplary screen shot of FIG. 2A by the notations of N/A.

Referring now generally to the Figures and particularly to FIG. 2B, FIG. 2B is an exemplary second screen shot 208 of an alternate modality of presentation of group names GRPNM.002-GRPNM.998 that are associated with a second exemplary theme THEME.999 and certain screen names SCRNM.001-SCRNM.999 that are further associated with the selected and associated group names GRPNM.002 & GRPNM.998. More particularly, the user device 104 renders an exemplary additional theme THEME.999 that is expressed by the words FOOD SECURITY, wherein the additional theme THEME.999 is expressed by the user device display screen 104A by visually displaying textual characters spelling the words FOOD SECURITY. In addition, a map 210 presents markers 212A-214N that each represent a location data LOC.001-LOC.999 that is associated by the social networking system 102 with a member account record MBR.001-MBR.999 of the system 100, wherein each represented member account record MBR.001-MBR.999 is associated with a group name GRPNM.002 & GRPNM.998 that is in turn associated with the additional exemplary theme THEME.999 of FOOD SECURITY. A user may position and hover a cursor over or proximate to a marker 212A-214N, whereupon the system 100 will cause a drop down screen 216 & 218 associated with a selected marker 212A-2414N to render and display information related to the selected marker 212A-214N. More particularly, an exemplary first drop down screen 216 presents information associated with an exemplary one hundred and fifth member account record MBR.105 that is associated with a second exemplary group name GRPNM.002, wherein the first drop down screen 216 presents information related to or comprised within the one hundred and fifth member account record MBR.105, including but not limited, an associated second group name GRPNM.002, a unique one hundred and fifth screen name SCRNM.105, a one hundred and fifth locale LOC.105, a one hundred and fifth text data document TXT.105, and/or a one hundred and fifth photographic data file PHOTO.105.

In addition, an exemplary second drop down screen 218 presents information associated with an exemplary seven hundred and forty third member account record MBR.743 that is associated with a nine hundred and ninety eighth exemplary group name GRPNM.998, wherein the second drop down screen 216 presents information related to or comprised within the forty third member account record MBR.743, including but not limited, an associated nine hundred and ninety eighth exemplary group name GRPNM.998, a unique seven hundred and forty third screen name SCRNM.743, a seven hundred and forty third locale LOC.743, a seven hundred and forty third text data document TXT.743, and/or a seven hundred and forty third photographic data file PHOTO.743.

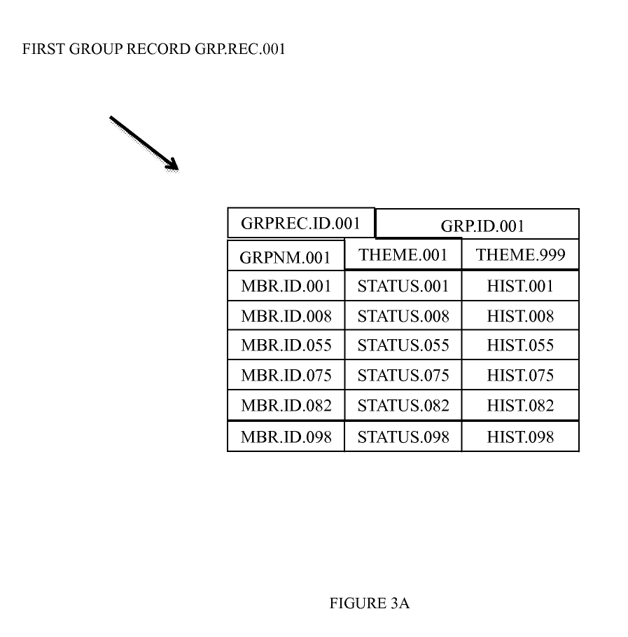

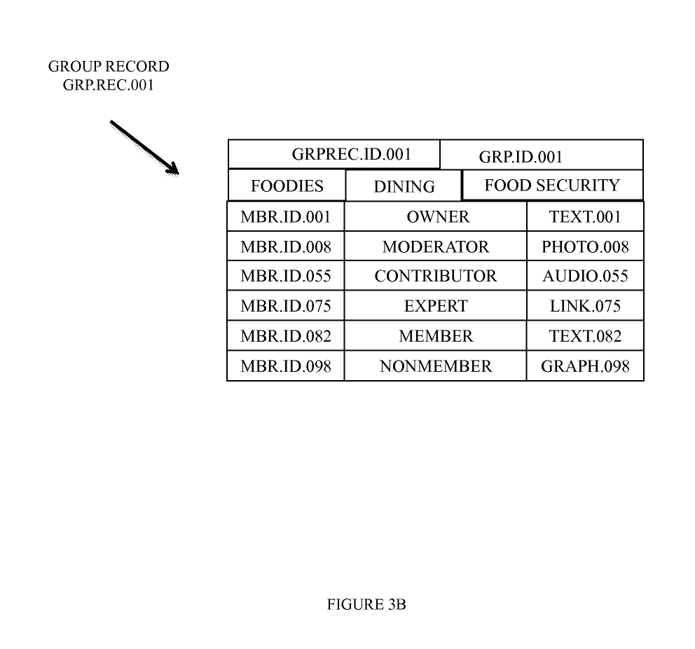

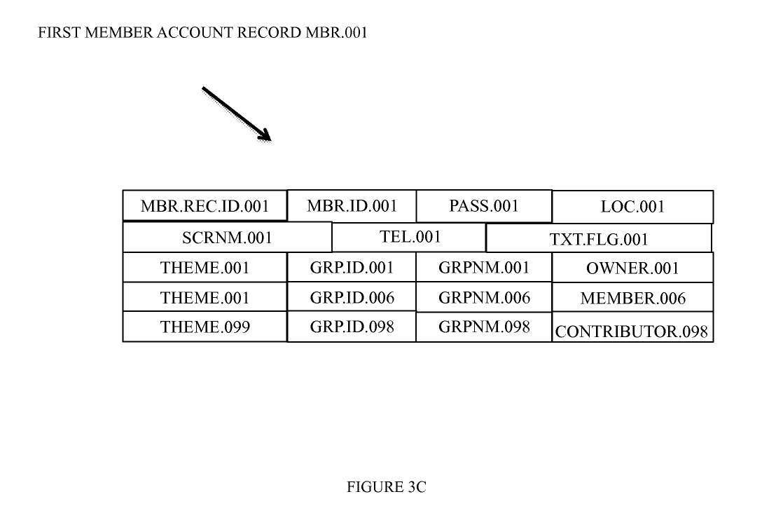

Referring now generally to the Figures and particularly to FIG. 3A, FIG. 3A is a representation of selected elements of an first exemplary group record GRP.REC.01, wherein a plurality of member records MBR.001-MBR.999 may be associated with one or more selected theme expressions THEME.01-THEME.999. It is understood that the contents referred to in the discussions of certain exemplary records GRP.REC-.001-GRP.REC.999, MBR.001-MBR.999, CR.REC.001-CR.REC.999 & CR.REC.999 are offered for clarity of explanation and are not meant as indicating limitations of the scope of the invented method. It is further understood that one or more theme expressions THEME.01-THEME.999 may comprise textual data, graphics data, photographic data and/or audio data.

The exemplary first group record GRP.REC.01 includes a group record identifier GRPREC.ID, a first group identifier GRP.ID.001, a first group screen name GRPNM.001, one or more theme expressions THEME.001 & THEME.999, and member data identifiers MBR.ID.001-MBR.ID.098 selected from individual member records MBR.001-MBR.999. The unique group record identifier GRPREC.ID identifies the comprising first group record GRP.REC.001 to the social networking system 102. The unique first group identifier GRP.ID.001 identifies the first instant group of member records as a group to the social networking system 102, whereas the unique first group screen name GRPNM.001 may be visually rendered by the devices 104 & 106 when the first group record GRP.REC.001 is selected. The theme expressions THEME.001 & THEME.999 associate the first group record GRP.REC.01 with individual themes. The status indicators STATUS.001-STATUS.098 are each individually associated with a member identifier MBR.ID.001-MBR.098 and indicate a status level within the group associated with the relevant member identifier MBR.ID.001-MBR.098. One or more status levels STATUS.001-STATUS.098 may direct the social networking system 102 to allow a privilege or limit a capability in reference to an associated member identifier MBR.ID.001-MBR.098. One or more history data fields HIST.001-HIST.098 that may contain textual, graphical, photographic and/or audio data previously submitted by or associated with a particular member identifier MBR.ID.001-MBR.098.

FIG. 3B is a representation of selected elements of the first exemplary group record GRPREC.001, wherein the first group screen name GRPNM.001 is shown to be the word FOODIES. FIG. 3B further shows that the first exemplary theme expression THEME.001 is the written word DINING and the additional exemplary theme expression THEME.999 is the written term FOOD SECURITY. It is understood, and shown by the first exemplary group record GRPREC.001, that a group record GRPREC.001-GRPREC.999 may be associated with more than one theme expression THEME.001-THEME.999.

The first exemplary group record GRPREC.001 further comprises the plurality of member records identifiers MBR.ID.001-MBR.ID.098 that are shown in FIG. 3B to each be associated with a group member status of OWNER, MODERATOR, CONTRIBUTOR, EXPERT, MEMBER or NONMEMBER. FIG. 3B also shows the exemplary first record contain textual TEXT.001 & TEXT.098, graphical GRAPH.098, photographic PHOTO.008, hyperlink data LINK.075, audio data AUDI0.055 previously provided by or associated with a particular member record identifier MBR.ID.001-MBR.098. The hyperlink data LINK.075 preferably includes a specific universal resource locator of the Internet and/or a domain name of the World Wide Web.

Referring now Referring now generally to the Figures and particularly to FIGS. 3C, FIG. 3C is a representation of selected elements of an exemplary first member account record MBR.001. The first member account record MBR.001 includes a first member record identifier MBR.REC.ID.001, a first member account identifier MBR.ID.001, a first member account password PASS.001, a first locale LOC.001, a first member screen name SCRNM.001, a first telephone number TEL.001, and a first text flag TXT.001. The first text flag TXT.001 is preferably a binary value space that by its immediate value indicates whether the first telephone number TEL.001 is enabled to send and/or receive text messaging. The first member account record MBR.001 further includes theme expressions THEME.001 & THEME.098 indicated to be of relevance to the comprising first member account record MBR.001 and selected group identifiers GRP.ID.001, GRP.ID.006 & GRP.ID.098 associated with the also specified theme expressions THEME.001 & THEME.098. Each included group identifier GRP.ID.001, GRP.ID.006 & GRP.ID.098 may be associated with a specific screen name GRPNM.001, GRP.006 & GRPNM.098 and a specific group participant status OWNER.001, MEMBER.006 & CONTRIBUTOR.098.

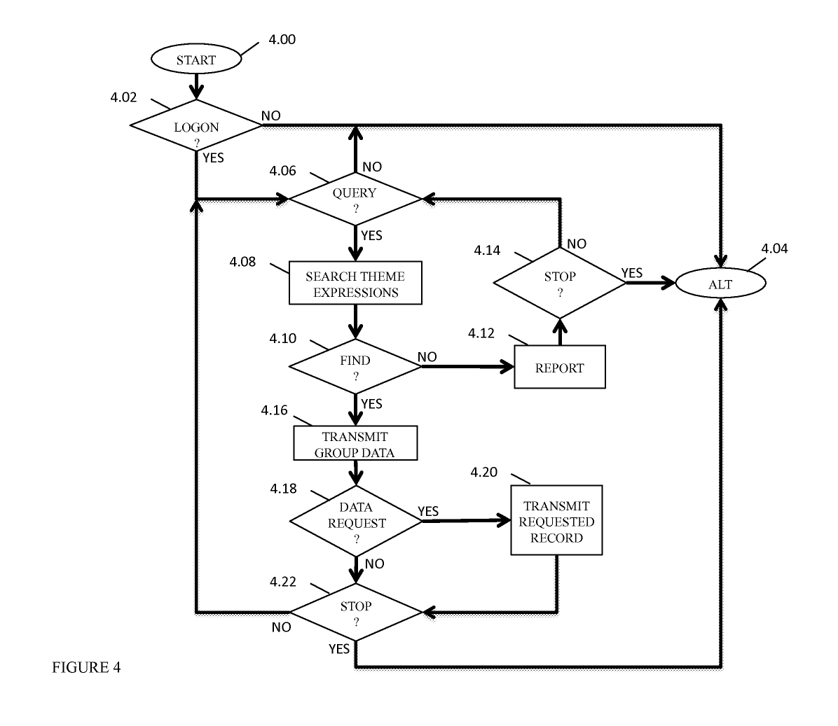

Referring now generally to the Figures and particularly to FIG. 4A, FIG. 4A is a flowchart of the social networking system of FIG. 1 interacting with a user in an enquiry related to a theme expression THEME.001-THEME.999. In step 4.02 the social networking system 102 determines of a user has provided required log in information, e.g., a member password PASS.001, via the user device 104 and proceeds on to step 4.04 to perform alternate operations if a required log in information is not detected by the social networking system 102 in step 4.02. It is understood that the social networking system 102 may be alternately adapted to enable a nonmember or other party to log on in step 4.02 without providing any authentication information. In step 4.06 the social networking system 102 determines of a user has provided submitted an enquiry referencing and regarding a thematic expression THEME.001-THEME.999, e.g., the word DINING or the term FOOD SAFETY, via the user device 104 and proceeds on to step 4.04 to perform alternate operations if no enquiry referencing and regarding a thematic expression THEME.001-THEME.999. When the social networking system 102 detects an enquiry referencing and regarding a theme expression THEME.001-THEME.999 in step 4.08, the social networking system 102 proceeds on to step 4.10 and employs the search engine module 114 to search the DBMS 118 for any group record GRPREC.001-GRPREC.999 that comprises the theme reference THEME.001-THEME.999 of the enquiry message detected in step 4.06. If no group record GRPREC.001-GRPREC.999 that comprises the theme reference THEME.001-THEME.999 of the enquiry message detected in step 4.06, the social networking system 102 proceeds from step 4.10 to step 4.12 and reports this failure to the user device 104. The social networking system 102 next determines in step 4.14 whether to (a.) exit the loop of steps 4.06 through 4.14 and proceed to step 4.04; or (b.) proceed from step 4.14 to execute step 4.06.

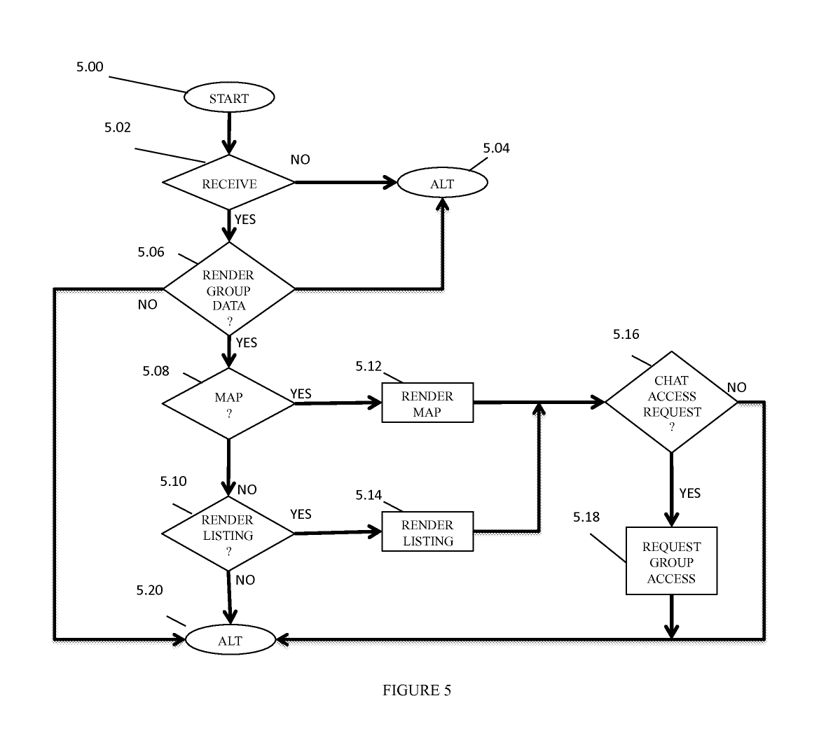

Alternatively, when the social networking system 102 determines in step 4.10 to have found a group record GRPREC.001-GRPREC.999 that references the theme expression THEME.001-THEME.999 of the enquiry message detected in step 4.06, the social networking system 102 provides data of one or more theme-matching group records GRPREC.001-GRPREC.999 to the user device 104 for rendering by the user device 104 as shown in FIG. 2A and FIG. 2B. When the social networking system 102 in step 4.18 receives a selection of an information request related to the data of one or more theme-matching group records GRPREC.001-GRPREC.999 transmitted in step 4.16, the social networking system 102 proceeds on to step 4.20 and transmits the requested data to the user device 104 in step 4.20. The social networking system 102 determines in step 4.22 whether to proceed to anther execution of step 4.06 or on to step 4.04. Referring now generally to the Figures and particularly to FIG. 5, FIG. 5 is a flowchart of the user device 104 processing a request to join a group associated with a group record GRPREC.001-GRPREC.999 of the invented system 100. The user device 104 determines in step 5.02 whether data of a group record GRPREC.001-GRPREC.999 has been received from the social networking system 102 in step 5.02 and proceeds onto step 5.04 and to perform alternate computational operations in step 5.04 when no newly received data of a group record GRPREC.001-GRPREC.999 has been received in step 5.02. In the alternative, the user device 104 determines in step 5.02 that data of a group record GRPREC.001-GRPREC.999 has been newly received from the social networking system 102 in step 5.02, the user device 104 proceeds on to step 5.06 and to determine if the user of the user device 104 has determined whether to render the newly received data of a group record GRPREC.001-GRPREC.999 as directed by the user in step 5.08 or step 5.10. When directed by the user, the user device 104 renders a map image as per FIG. 2B presenting the newly received data of a group record GRPREC.001-GRPREC.999 in step 5.12 or alternately as a listing in step 5.14 as per FIG. 2A.

The user device 104 determines in step 5.16 whether the user has directed the user device to request access to and participation in a group of the social networking system 102 associated with a group record GRPREC.001-GRPREC.999, and when directed by the user transmits a request to accordingly access the social networking system 102 in step 5.18. The user device 104 may proceed from 5.06, 5.16 or 5.18 to step 5.20 and to perform additional and alternative computer operations.

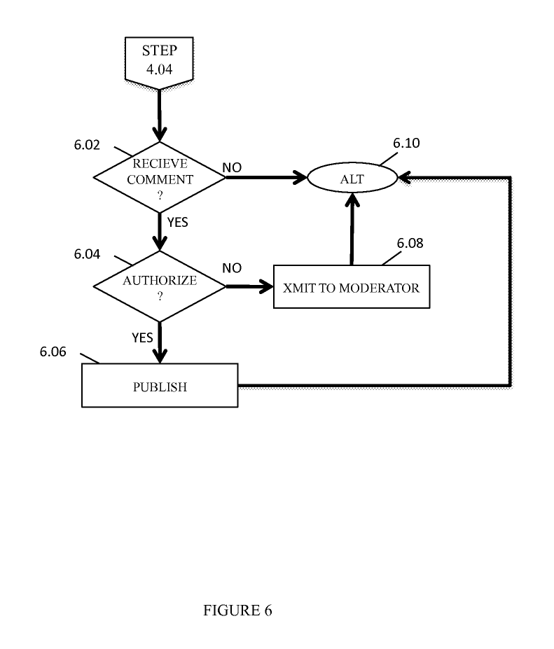

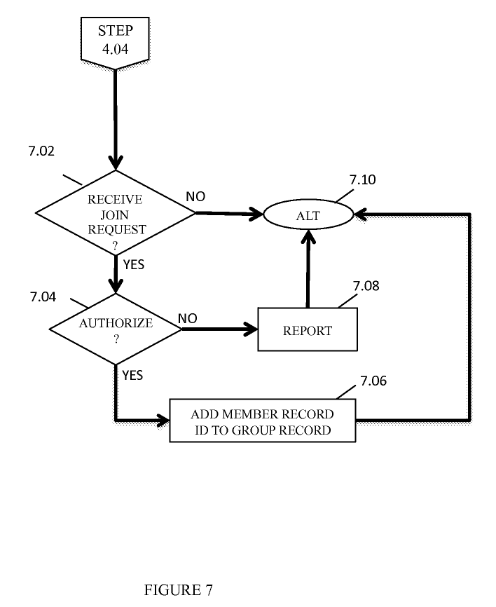

Referring now generally to the Figures and particularly to FIG. 6, FIG. 6 is a flowchart of the social networking system 102 processing a request to post a message within a group chat related to a group defined by a group record GRPREC.001-GRPREC.999. When the social networking system 102 determines in step 6.02 that a message has been received from the user device 104 to post a comment in a group chat related to a group record GRPREC.001-GRPREC.999 specified by the user device 104, the device determines whether to authorize a posting of the received comment in step 6.04 and may determine to publish in step 6.06 the comment received from the user device 104 to the indicated chat. Alternatively, the social networking system 102 may proceed from step 6.04 to transmit to the moderator the request and comment received from the user device 104 to a group moderator's network address in step 6.08. The social networking system 102 may proceed from step 6.02, step 6.06 or step 6.08 to step 6.10 and to perform additional and alternative computer operations.

Referring now generally to the Figures and particularly to FIG. 7, FIG. 7 is a flowchart of the social networking system 102 processing a request to join a group related to a group defined by a group record GRPREC.001-GRPREC.999. When the social networking system 102 determines in step 7.02 that a message has been received from the user device 104 to post a comment in a group chat related to a group record GRPREC.001-GRPREC.999 specified by the user device 104, the device determines whether to authorize an inclusion of a member identifier MBR.ID.001-MBR.ID.999 in step 7.04 in a group record GRPREC.001-GRPREC.999 referenced in the request examined in step 7.0. The social networking system 102 may to include in step 7.06 the member identifier MBR.ID.001-MBR.ID.999 received from the user device 104 in the referenced group record GRPREC.001-GRPREC.999. Alternatively, the social networking system 102 may proceed from step 7.04 to transmit to the moderator the request and group record reference received from the user device 104 to a group moderator's network address in step 7.08. The social networking system 102 may proceed from step 7.02, step 7.06 or step 7.08 to step 7.10 and to perform additional and alternative computer operations.

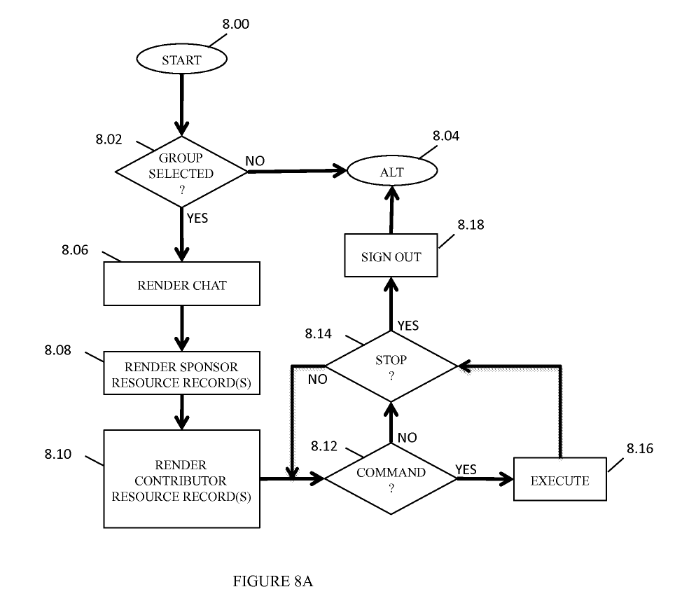

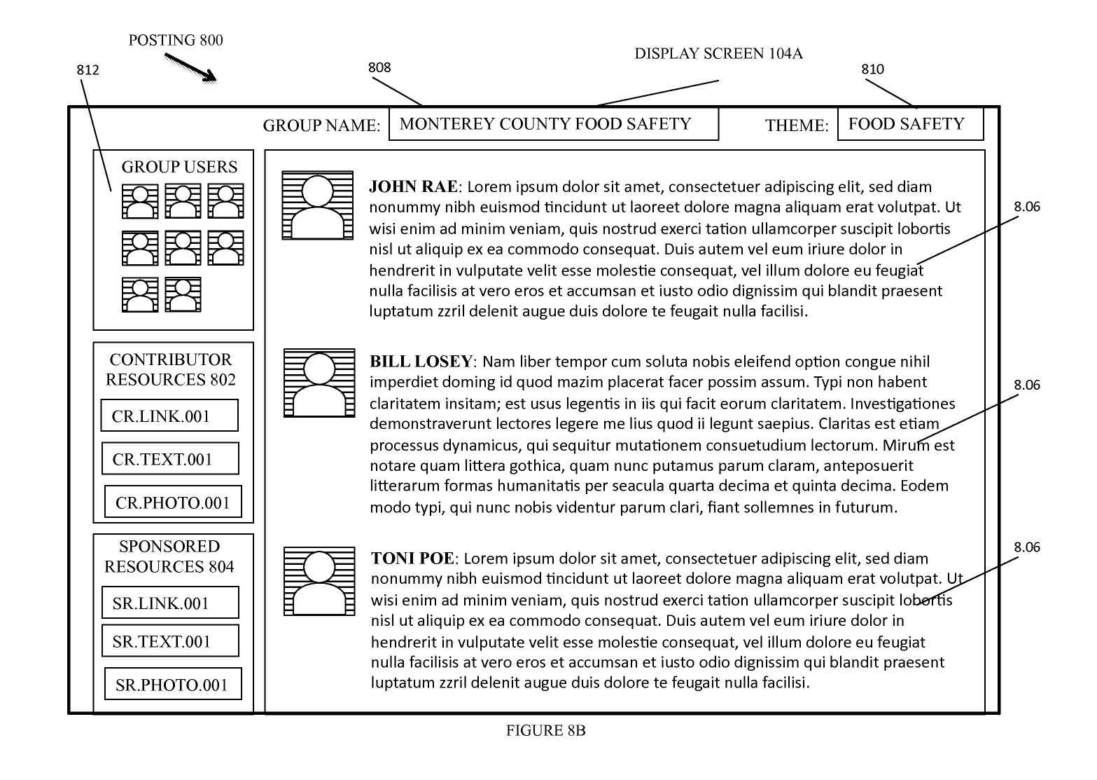

Referring now generally to the Figures and particularly to FIG. 8A, FIG. 8A is a flowchart of the social networking system 102 in a posting 800 of a chat session related to a group record GRPREC.001-GRPREC.999. In step 8.02 the social networking system 102 determines if a command to render a group chat has been received, and if no such command has been received, the social networking system 102 proceeds on to step 8.04 and to perform additional and alternate computational processing. Alternatively, when a command to render a group chat has been determined to have been received by the social networking system 102 in step 8.02, the social networking system 102 publishes the requested chat for access by web browsers or other suitable means known in the art in step 8.06. The social networking system 102 additionally posts sponsors resource information associated with the selected group record GRPREC.001-GRP.999 in step 8.08 in association with the chat of step 8.06, and further posts contributor resource information in step 8.10 in association with the chat of step 8.06. The social networking system 102 then proceeds through the loop of steps 8.12, 8.14 and 8.16 and executes in step 8.16 any received commands related to the posted chat and posted resource information, When the social networking system 102 determines to, or complies with a command to, end the posting of the chat in step 8.14, the social networking system 102 proceeds from step 8.14 to step 8.18 and ceases publishing the chat and resource information of steps 8.06, 8.08 and 8.10.

Referring now generally to the Figures and particularly to FIG. 8B, FIG. 8B is an illustration of a group chat 800 with resource information 802 & 804 as published by the social networking system 102 via the invented system 100 and the network 108. The group chat 800 provides text images 806 of dialog input from users, a group name rendering 808 of a previously assigned group name GRPNM.001-GRPNM.999, a theme expression rendering 810 of previously assigned associated theme THEME.001-THEME.999, and/or additional visual, audio and/or textual data renderings 812 of information related to group members, chat participants, and/or the invented system 100. The contributor resource image 802 may include renderings of a hyperlink CR.LINK.001, textual data CR.TEXT.001, photographic data CR.PHOTO.001 and/or renderings of additional data types. In addition, the sponsor resource image 804 may include renderings of a sponsored hyperlink SR.LINK.001, sponsored textual data SR.TEXT.001, sponsored photographic data SR.PHOTO.001 and/or renderings of additional sponsored information of additional data types.

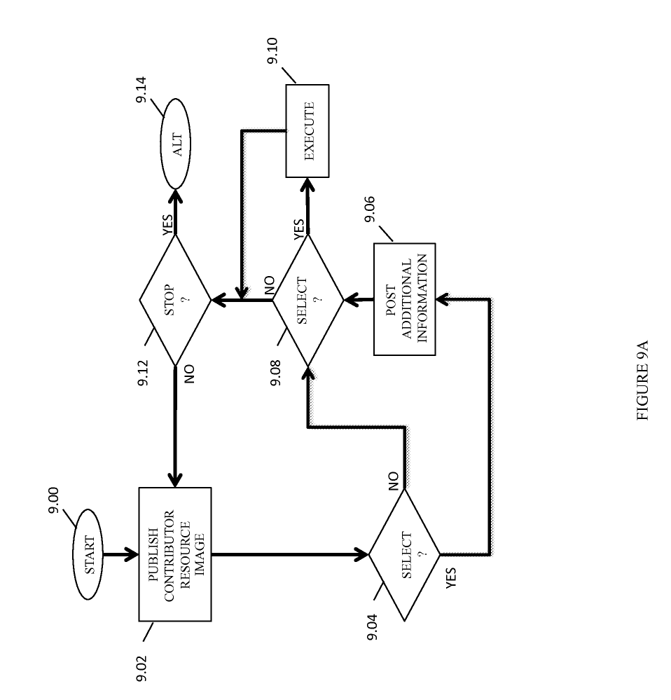

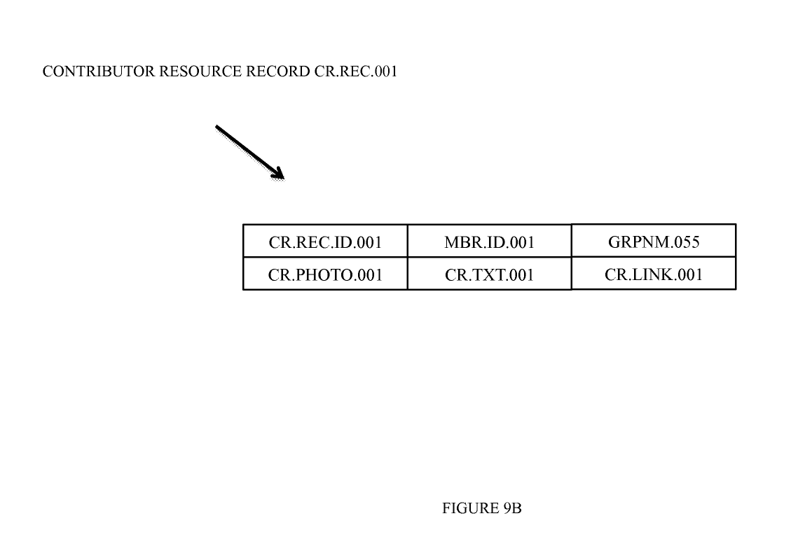

Referring now generally to the Figures and particularly to FIG. 9A, FIG. 9A is a flowchart of the social networking system 102 in posting a chat session related to a group record GRPREC.001-GRPREC.999. In step 9.02 the social networking system 102 publishes information maintained in a contributor resource record CR.REC.001-CR.REC.999. In step 9.04 the social networking system 102 determines if a request to publish additional information has been received, and posts additional information related to the contributor resource record CR.REC.001-CR.REC.999 of step 9.02, and posts requested additional information in step 9.06. in step 9.08 the social networking system 102 determines if any executable commands have been received via the network 108 in step 9.08 related to the published information of steps 9.02 and optionally 9.06, and executes any detected related commands in step 9.10.

When the social networking system 102 in step 9.12 determines to, or complies with a command to, end the posting of the information of steps 9.02 and 9.06, the social networking system 102 proceeds to execute step 9.14 and ceases publishing the contributor resource information of steps 9.02 and 9.06, and optionally to perform additional computational operations in step 9.14.

Referring now generally to the Figures and particularly to FIG. 9B, FIG. 9B is an exemplary first contributor resource record CR.REC.001 that is accessed in the process of FIG. 9A. The first contributor resource record CR.REC.001 includes a first contributor resource record identifier CR.REC.ID.001, a member identifier MBR.ID.001 of a member have the status of CONTRIBUTOR in the group related to the first contributor resource record CR.REC.001, the group name GRPNM.055 of an associated fifty-fifth group record GRPREC.055. The first contributor resource record optionally further includes contributor resource photo data CR.PHOTO.001, contributor resource text data CR.TXT.001, and/or a contributor resource hyperlink CR.LINK.001.

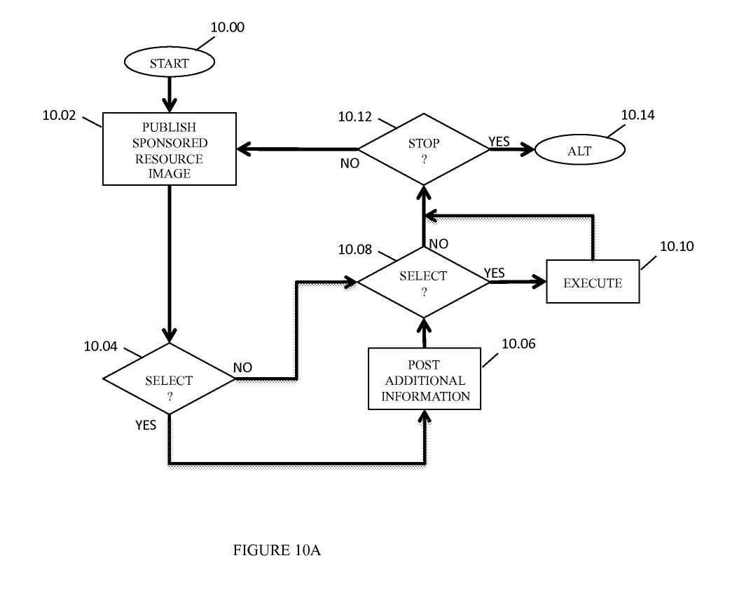

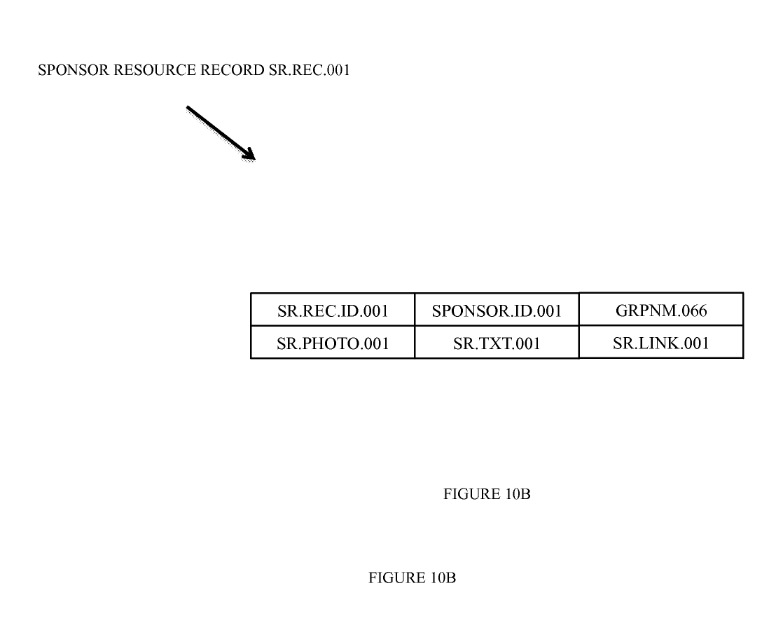

Referring now generally to the Figures and particularly to FIG. 10A, FIG. 10A is a flowchart of the social networking system 102 in posting a chat session related to a group record GRPREC.001-GRPREC.999. In step 10.02 the social networking system 102 publishes information maintained in a sponsor resource record CR.REC.001-CR.REC.999. In step 10.04 the social networking system 102 determines if a request to publish additional information has been received, and posts additional information related to the sponsor resource record CR.REC.001-CR.REC.999 of step 10.02, and posts requested additional information in step 10.06. in step 10.08 the social networking system 102 determines if any executable commands have been received via the network 108 in step 10.08 related to the published information of steps 10.02 and optionally 10.06, and executes any detected related commands in step 10.10.

When the social networking system 102 in step 10.12 determines to, or complies with a command to, end the posting of the information of steps 10.02 and 10.06, the social networking system 102 proceeds to execute step 10.14 and ceases publishing the sponsor resource information of steps 10.02 and 10.06, and optionally to perform additional computational operations in step 10.14.

Referring now generally to the Figures and particularly to FIG. 10B, FIG. 10B is an exemplary first sponsor resource record SR.REC.001 that is accessed in the process of FIG. 10A. The first sponsor resource record SR.REC.001 includes a first sponsor resource record identifier CR.REC.ID.01 and another exemplary group name GRPNM.066 of an associated sixty-fifth group record GRPREC.066. The first sponsor resource record optionally further includes sponsor resource photo data SR.PHOTO.001, sponsor resource text data SR.TXT.001, and/or a sponsor resource hyperlink SR.LINK.001.

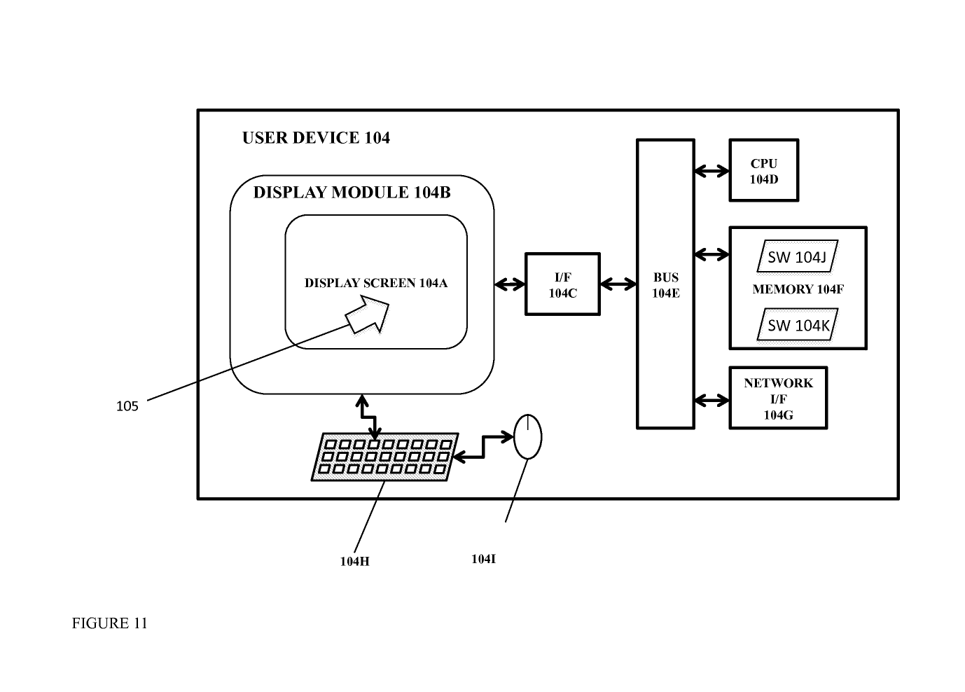

Referring now generally to the Figures and particularly FIG. 11, FIG. 11 presents a block diagram of elements of the user device 104. The display screen 104A is shown to be a component of a display module 104B. The display module 104B is bi-directionally communicatively coupled through a display module interface 104B to a central processing unit 104D via an internal communications bus 104E. The central processing unit 104D is further bi-directionally communicatively coupled through the internal communications bus 104E to a system memory 104F and a network interface 104G. The network interface 104G further bi-directionally communicatively couple the central processing unit 104D with the network 108. A computer keyboard 104H and a selection device 104I are communicatively coupled with the display module 104B and enable the user to position the cursor 105 within the display screen 104A. The selection device 104I may be or comprise a computer mouse, touchpad, track ball or other suitable point-and-click computer selection device known in the art.

It is further understood that the user device 104 further comprises a web browser software 104J and system software 104K that in combination enable the user device 104 to be directed to effectively engage in interaction with the social networking system 102, the network 108 and other elements of the invented system 100. The web browser 104J may be or comprise a commercially or generally available web browser software such as, but not limited too, a SAFARI (™) web browser as provided by Apple, Inc. of Cupertino, Calif., a INTERNER EXPLORER (™) web browser as provided by Microsoft Corporation of Redmond, Wash., or a FIREFOX (™) as provided by the Mozilla Foundation of Mountain View, Calif. The system software 104K preferably includes an operating system and additional software code that enables the user of the user device 104 to direct the user device 104 to effectively engage in interaction with the social networking system 102, the network 108 and other elements of the invented system 100 in accordance with the aspects and steps of the invented method as disclosed herein.

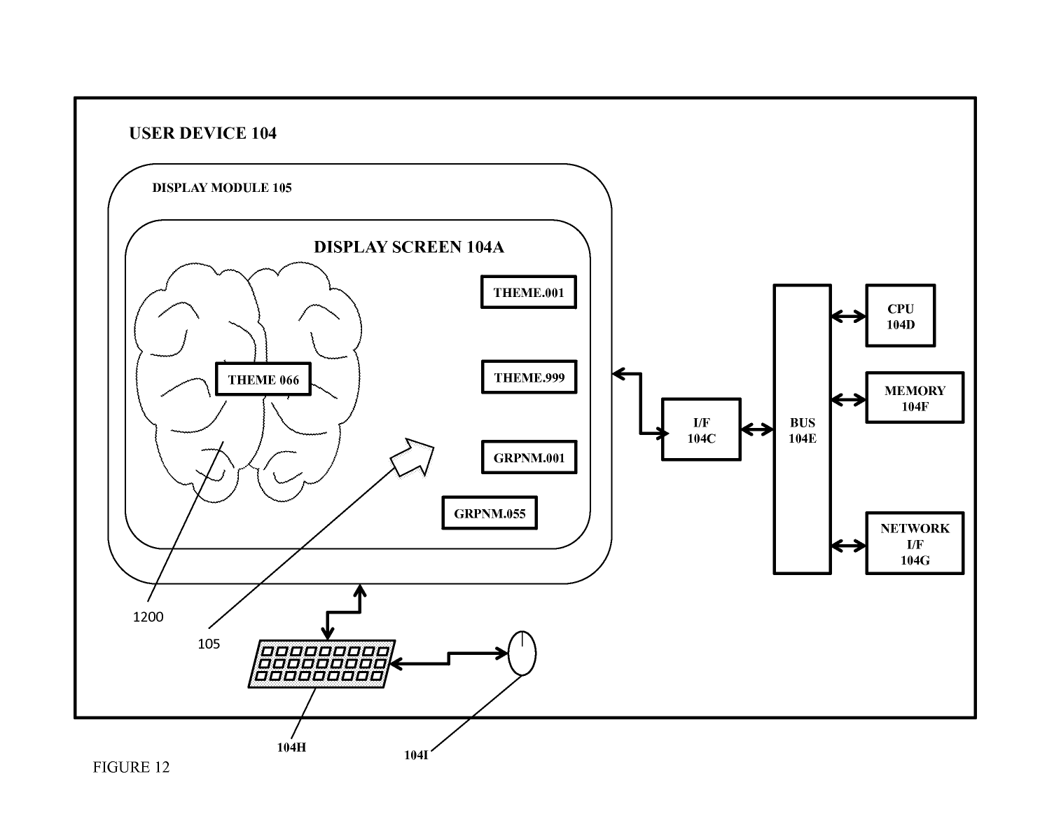

Referring now generally to the Figures and particularly FIG. 12, FIG. 12 illustrates an optional aspect of the UI module 116 wherein a brain icon 1200 is displayed at the user device 104 and the user may drag and drop member records MBR.001-MBR.999 that comprise theme expressions THEME.001-THEME.999 and/or group names GRPNM.001-GRPNM.999 into the brain icon 1200 and thereby direct the social networking system 102 to populate the user profile with screen names SCRNM.001-SCRNM.999 of member account records MBR.002-MBR.999 into the exemplary first member account record MBR.001. For example, should the user apply the selection device 1041 to drag and the representation of the first group record GRPREC.001 into the brain icon, all screen names SCRNM.001-SCRNM.999 included within the first group record GRPREC.001 will be written into, or associated with and made accessible via, the exemplary first member record MBR.001. Furthermore, should the user apply the selection device 1041 to drag and the representation of the first theme expression THEME.001 into the brain icon, all screen names SCRNM.001-SCRNM.999 of member records MBR.002-MBR.999 that reference the first theme expression THEME.001 will be written into, or associated with and made accessible via, the exemplary first member record MBR.001. The user may thus acquire the ability to send messages to other members identified by member records MBR.002-MBR.999 of the invented system 100 by referencing screen names SCRNM.002-SCRNM.999. The user may thus elect to communicate with social network members on the basis of self-expressed interests in themes, e.g., topics, issues and concerns.

In another optional aspect of the invented method, one or more theme expressions THEME.001-THEME.999 may be color-coded when rendered or visually associated with a same color within the display screen 104A to indicate that that any two or more theme expressions THEME.001-THEME.999 being rendered with a same color-code or color association are indicated to be comprised within or related to a same category or quality of thought, idea, concept, area of expertise, and/or area of interest. Offered as an example, where two themes expressions of FOODIE and DINING might be rendered a same color-code or color association of a shade of green to indicate that both themes are related to nutrition or agriculture.

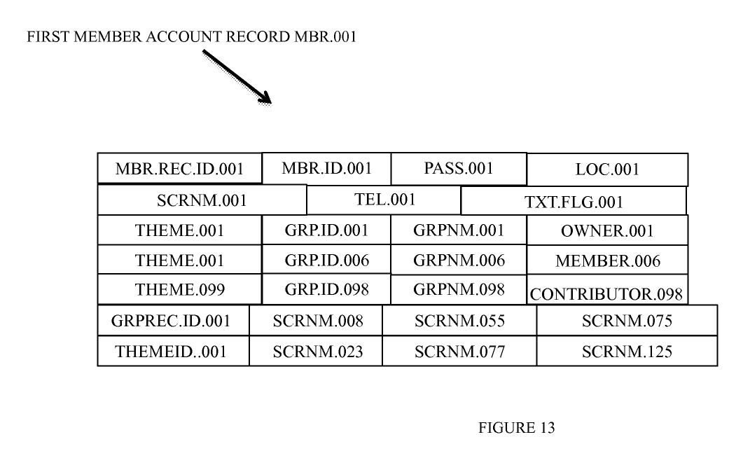

Referring now generally to the Figures and particularly FIG. 13, FIG. 13 illustrates the exemplary first member account record wherein the first group record identifier GRPREC.ID.001 and screen names SCRNM.008, SCRNM.055 & SCRNM.075 associated with the member account identifiers MBR.ID.008, MBR.ID.055 & MBR.ID.075 that are included in the first group record GRPREC.001 have been dropped into and included within the first member account record MBR.001 by the described in the discussion of FIG. 12. Furthermore, the first theme expression THEME.001 and certain screen names SCRNM.023, SCRNM.077 & SCRNM.125 associated with the member account records MBR.002-MBR.999 that comprise a reference to the first theme expression THEME.001 have been dropped into and included within the first member account record MBR.001 by the described in the discussion of FIG. 12.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

I claim:

1. A method for enabling communication of people on a social network, each person having a device with access to an electronics communications network (“comms network”), the method comprising:
(a) providing a central server that maintains a list of social network members with unique member identifiers;
(b) operatively connecting at least device to the central server via the comms network;
(c) responding to a request for group membership data submitted to the comms network in association with a theme from the device:
(1) said central server accepting the request from the device;
(2) said central server determining if the theme is registered as previously associated with a group record;
(3) if the theme is associated with a group record, rendering information associated with the group record in association with at least one group member geolocational position at said device.

2. The method of claim 1 wherein said device is a cellular telephone.

3. The method of claim 2 wherein at least member is associated by the social network with a telephone number.

4. The method of claim 1 wherein at least one member is associated by the social network with a user name.

5. The method of claim 1 wherein at least one member is associated by the social network with a password.

6. The method of claim 5 wherein said central server accesses device through an application running on a server operatively connected to the comms network.

7. The method of claim 1, wherein the at least one group member geolocational position is rendered within a listing.

8. The method of claim 1, wherein a geolocational position is associated by the central server with a user of the device.

9. The method of claim 1, wherein the at least one group member geolocational position is rendered within a map image.

10. The method of claim 9, wherein the at least one group member geolocational position is simultaneously rendered with the member geolocational position in visual association within the map image.

11. The method of claim 1, wherein the theme is rendered in association with an image by the device.

12. The method of claim 1, wherein a third member of the social network is assigned a moderator authority over the theme within the social network.

13. The method of claim 1, wherein a fourth member of the social network is assigned a contributor status in association with the theme within the social network.

14. The method of claim 1, wherein one or more themes are associated with a same group record by the social network.

15. The method of claim 1, wherein one or more resources are associated with the theme by the social network.

16. The method of claim 15, wherein at least one resource is associated with a group member.

17. The method of claim 1, wherein one or more additional themes are associated with the group record.

18. The method of claim 17, wherein one or more additional themes are associated with at least one group member.

19. A system for automatically connecting people on a social network, each person having a device with access to an electronics communications network (“comms network”), said system comprising:
(a) a communications device (“device”) adapt to bi-directionally communicate via the comms network; and
(b) a central adapted to:
operatively connect at least device to the central server via the comms network;
(c) respond to a request for group membership data submitted to the comms network in association with a theme from the device:
(1) accept the request from the device;
(2) determine if the theme is registered as previously associated with a group record;
(3) if the theme is associated with a group record, render information provided within a matching group record in association with at least one group member geolocational position at said device.

20. The system of claim 19, wherein the comms network comprises the Internet.
